(19) United States
(12) Patent Application Publication
(10) Pub. No.: US 2003/0033388 A1
(43) Pub. Date: Feb. 13, 2003

(54) Method and apparatus for controlling a plurality of security gate operating mechanisms

(76) Inventors: Wayne C. Hom, Rancho Santa Margarita, CA (US); Laszlo Racz, Yorba Linda, CA (US)

Correspondence Address: LEVIN & HAWES, P O BOX 4140, LAGUNA BEACH, CA, 92652

(21) Appl. No.: 09/925,950

(22) Filed: Aug. 9, 2001

(51) Int. Cl. G06F 15/177

(52) U.S. Cl. 709/220

(57) ABSTRACT

A method and apparatus are disclosed for controlling the operation of a plurality of security gate operating mechanisms, which may comprise providing a central computer system, including an associated memory system; providing a network connection over one of the Internet, world wide web, an intranet, an extranet or a combination of one or more of these, between the central computer system and each of the plurality of security gate operating mechanisms; storing in the associated memory system software used in operating at least some of the respective security gate operating mechanisms; storing in the associated memory system operating system parameters, or a respective table(s) and/or sub-tables for each of the respective security gate operating mechanisms; providing over the network, the software and operating parameters to respective ones of the security gate operating mechanisms on a client-serve basis running the software on the central computer system.

### FIELD OF THE INVENTION

The present invention relates to the field of security gates, particularly ones controlled by a control system employing a plurality of operating parameter settings.

### RELATED APPLICATIONS

This application is related to the contemporaneously filed patent application having the same assignee, filed under Attorney docket No. 2019-317, the disclosure of which is hereby incorporated by reference.

### BACKGROUND OF THE INVENTION

It is well known to have security gates with a control system that is responsive to a number of control settings or parameters. By way of example, the operation of the gate may be responsive to a code received by the system through any of a number of ways, e.g., a “garage-door-opener” type of optical, sound or radio transmission device that the control system is capable of receiving and which is encoded to open the security gate. Another example could be the entry of a code through a key pad, or other similar input device, located at the site of the security gate. Still a further example could be the receipt of a signal from a remote location over, e.g., the telephone lines, including the Public Switched Network or wireless, or like communication devices such as a pager-type system, etc. It is also known to have special control parameters that the security gate system is capable, ordinarily through software programming and parameter settings, to specially control. For example, specific codes or coded transmitter devices may be able to induce the control system to recognize an authorized request to activate the security gate only a certain times or certain dates/times. Therefore, for example, the system may recognize the code given to, e.g., a delivery person only on a specific date or only with a specific period of time during each day, or a combination of both. An authorization for access granted on a more random basis, e.g., by the occupant of a unit within the complex protected by the security gate in response to a party seeking access having contacted the occupant, may only remain active for a few minutes, or an hour or for some other specified period of time. Similarly, the code for a person no longer authorized access may be permanently deleted from those that the system recognizes as authorized entrants, e.g., in case the person has kept a coded entry device or retains knowledge of the entry code. Various other parameters for the operation of the security gate can also be set for control at the control system, e.g., speed, the reaction to encountering an obstacle in opening or shutting, reaction of the system to attempts to breach the gate system, by, e.g., tailgating and authorized entrant, alarm settings, reset conditions, etc. It is also known to set or upgrade these settings/parameters remotely through some form of communication network.

Problems can arise in such setting or upgrading where an attempt is made to enter or leave through the security gate while setting or resetting is in progress.

These problems can include the security gate continuing to respond the an earlier and now invalid parameter during the specific entry occurring as the parameters bre being reset, or even continuing thereafter because the simultaneous operation of the control system and attempted resetting of the parameters has left unchanged the original parameter setting that was intended to be changed. Worse yet, the newly intended parameter and the previously existing parameter may neither be set during this time when the control system is both operating the security gate and attempting to process instructions for the resetting the parameter, which could in the worst case cause the gate not to function at all or, equally troubling, to allow unauthorized entrance of egress.

In addition, problems arise in making operating and/or access parameter changes to a plurality of remote sites at one time. For example, there may be changes in operating parameter settings what are desired to be made with, e.g., the change in seasons. Varying prevailing weather conditions may dictate such changes. In addition, changes in access authorization for a large number of locations may be needed, e.g., with the change in a landscape contractor or the like for a number of different complexes having a security gate system operated by the same management company, or for a single complex having a number of different gate locations, or, e.g., the change in a routine day that certain deliveries from a certain merchant or service provider are scheduled to occur, and the like. Furthermore, central control of parameters for both operation and access may be more desirable than the loading of software on the local controller/gate operating mechanism and/or the maintenance of a local memory or memories for controlling the security gate system. These and like shortcomings of the existing systems are avoided by the present invention.

### SUMMARY OF THE INVENTION

A method and apparatus are disclosed for controlling the operation of a plurality of security gate operating mechanisms, which may comprise providing a central computer system, including an associated memory system; providing a network connection between the central computer system and each of the plurality of security gate operating mechanisms; storing in the associated memory system software used in operating at least some of the respective security gate operating mechanisms; storing in the associated memory system operating system parameters for each of the respective security gate operating mechanisms; providing over the network the software and operating parameters to respective ones of the security gate operating mechanisms. The method and apparatus may further comprise storing the operating parameters a respective table(s) and/or sub-tables stored in the associated memory system; updating the content of the respective table(s) and/or sub-tables for a respective security gate operating system; providing over the internet the updated respective table(s) and/or sub-tables to the respective security gate operating mechanism; verifying that the updated table(s) and/or sub-tables have been received at the respective security gate operating mechanism; substituting the updated table(s) and/or sub-tables at the respective security gate operating mechanism for a currently used table(s) and/or sub-table. The method and apparatus may further comprise a network connection over one of the Internet, the world wide web, a local area network, a wide area network, an intranet, an extranet or a combination of one or more of these. The method and apparatus may further comprise communicating over the network to the server computer system from at least one of the respective security gate operating mechanisms and/or a remote location a request to update an operating parameter and/or operating system or application software at the respective security gate operating mechanism; processing the requested update at the server computer system; and providing for delivery to the respective security gate operating system either the updated operating parameters and/or operating system or applications software. The method and apparatus may further comprise providing the software to a respective one of the security gate operating systems on a client-server basis running the software on the central computer system as the server and utilizing the operating parameters as stored in the associated memory, or may further comprise providing over the network some of the software and/or operating parameters to a respective one of the security gate operating mechanisms and providing access to some of the software to the respective one of the security gate operating systems on a client-server basis running the software on the central computer system as the server and utilizing the operating parameters as stored in the associated memory and/or as stored at the security gate operating mechanism.

### BRIEF DESCRIPTION OF THE DRAWINGS

FIG. 1 shows a schematic diagram of a control system for a security gate according to the present invention.

FIG. 2 is a schematic diagram of another aspect of the security gate operating system of FIG. 1 according to the present invention.

### DETAILED DESCRIPTION OF THE PREFERRED EMBODIMENTS

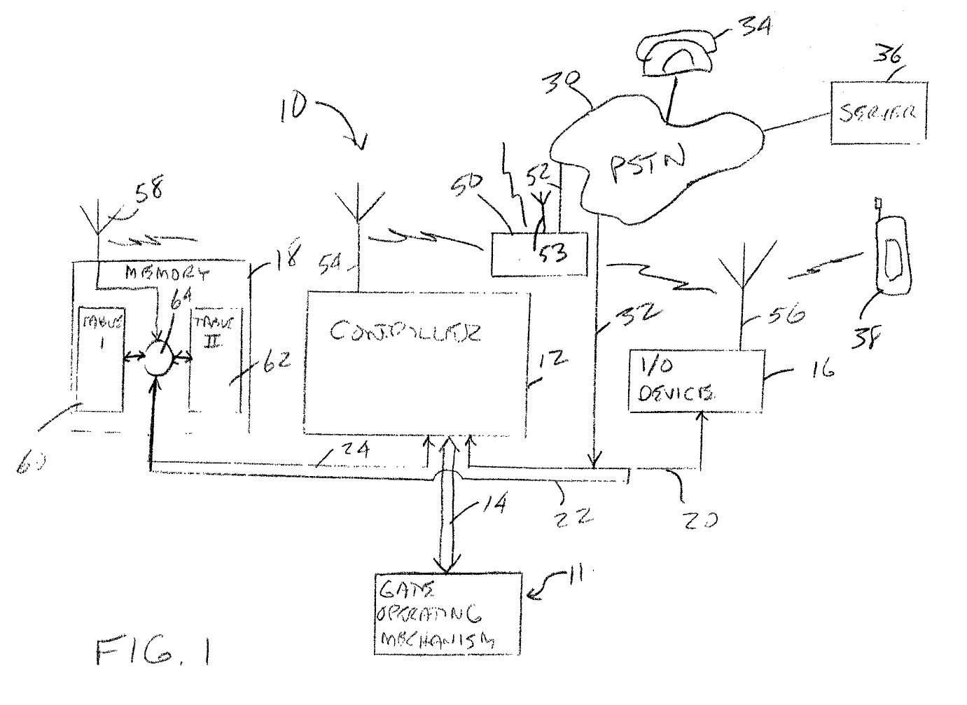

Turning now to FIG. 1 there is shown a schematic diagram for a control system 10 for a security gate operating mechanism 11 according to an embodiment of the present invention. The system 10 may include a security gate operating mechanism controller 12. The security gate operating mechani9sm controller 12 can be connected to the security gate operating mechanism 11 by an information transfer bus. The gate operating mechanism may include a drive motor and various sensors connected directly or indirectly to the drive motor or the gate itself, to sense such things as position and movement of the gate, motor operating temperature, speed, etc., inertial force on the gate, etc. The information transfer bus may transfer from the security gate operating mechanism and or from the sensors connected directly or indirectly to the gate operating mechanism information to the controller 12. The information transfer bus 14 may transfer from the controller information/commands, such as commands to start/stop the drive motor, increase/decrease the drive motor speed, increase/decrease cooling fluid supply to the drive motor, etc., which are generated by the controller 12 in response to the information received from the gate operating mechanism and/or associated sensors, and in accordance with preselected and programmed control algorithms. It will be understood that the controller 12 and gate operating mechanism 11 may be a part of the same unit, e.g., located on the same printed circuit board (not shown) or in the same gate controller housing (not shown) or they could be remote from each other, e.g., with the gate operating mechanism at the location of the gate and the controller 12 and other equipment associated with the controller function in a remote centralized unit controlling the operation of the one or many gates, and/or in a remote building, etc. It will also be understood that the remote gate operating mechanism 11 may also have a controller function built into it, e.g., in the form of a microprocessor on the board at the gate operating mechanism 11 which can assume the functions set forth herein for the controller 12 or some subset of them, leaving the remainder to the controller 12.

The controller 12 may also be in communication with an input/output device 16. The input output device 16, shown here schematically and generically will also be understood to have a number of possible implementations. The I/O device may be a full or truncated computer keyboard I/O. It may be positioned at the security gate in or near the unit housing the gate operating mechanism or remotely with the controller 12, or a combination of these possible locations. The I/O device 16 can serve to update the controller 12 as to operating parameters that he security gate is to operate within, e.g., speed of movement, location of a first open and a second shut position, hereinafter referenced as operating parameter information. In addition, the I/O device 16 may serve to input or modify/update other information, e.g., access information, which may include, e.g., the identity of certain vehicles, individuals, company vehicles, etc. that are authorized entry, and/or codes or other identifying information, e.g., garage-door opener style devices that can communicate with the I/O device 16, as is well known, e.g., in ultrasound, radio, infrared, or the like, or which can be input through the I/O device 16, I the form of a name, or a personal identification number (“PIN”) or other code and/or a combination of these to indicate authorized access. In addition, the controller 12 and gate operating mechanism 11 may be responsive to certain identified authorized entrants only on certain days of the week, or a particular single date or dates, or within certain range of times on any given date, or any combination of these factors, e.g., to allow a unique delivery of an item to a resident in a complex protected by the security gate on a certain date between certain hours, but not otherwise, or a routine entry of some scheduled delivery or pick-up service, e.g., laundry or dry cleaning, or some scheduled arrival of a cleaning service, etc.

A memory 18, which may be a part of the controller 12, and/or of the controller 12 and gate operating mechanism 11, i.e., contained within the same housing as either or both of them, depending upon the configuration of the controller 12 and operating mechanism 11 from the possible configurations noted above. The memory 18 may be communicated to directly through the I/O device 16, or through the controller 12, either directly or indirectly from the I/O device 16, or through some other communication channel, e.g., an antenna 58, which will be understood to be generic to communication from other than the controller 12 and/or I/O device 16, e.g., over a telephone line, cable connection or otherwise. Likewise, the entire system 10 can be accessed and controlled and/or have its operating or access parameters input, updated or modified through a communication system as is well known in the art and which includes at least the elements noted in FIG. 1.

The communication/control system can include a public switched telephone network (“PSTN”) 30, which as is well known in the art can be accessed through, e.g., a telephone handset 34, a remote server computer 36, a wireless telephone, pager, palm pilot, personal digital assistant or the like. Wireless connection to the PSTN may be direct or indirect through, e.g. a wireless central station 50. The wireless central station may be connected to the PSTN 30 through a line 52 or an antenna 53. Other antennae 54, 56 and 58 may allow wireless communication from or through the PSTN to respectively the controller 12, I/O device 16 and/or memory 18, or may, alternatively allow direct wireless communication between the Controller 12, I/O device 16 and memory 18. It will be understood that the information transfer bus 14 may be wireless as well.

With all of the possible communication links to the memory 18 to input, update and modify the various parameters stored therein the opportunity exists for several types of unintended and/or inadvertent failures of the security gate operating mechanism to appropriately respond to the existing circumstances and either fail to open when required or open when not appropriately authorized to open, as examples. This can occur if the gate operating mechanism 11 receives a signal indicating, e.g., that access is demanded. This can be, e.g., through the sensing of a vehicle in an access position by, e.g., a magnetic sensor, or a push button or the receipt of an ultrasound, radio or infrared access signal, before the access parameters are input into the memory 18 and/or while they are being input or updated or modified. In this even, the system may be triggered to respond to a set of stored parameters that are not complete, or that are in the process of being changed. In such an event there are several inappropriate responses that can occur. For example the system may fail to respond at all, denying access where access should be allowed or respond to outdated parameters, e.g., allowing access where access should be denied. According to the present invention, the memory 18 can be divided into at least two parameter sections 60 and 62, labeled, e.g., Table I and Table II. A means, such as a switch 64 can be used, e.g., to control the entry of parameter information into the respective Table I 60 and Table II 62, and access to each respective Table I 60 and Table II 62, such that unless all of the parameters contained in the memory Table I are stored in the memory Table I 60 or Table II 62, respectively, that portion of the memory cannot be accessed for control purposes. This may be done, e.g., through the use of software and stored flags for each entry, which if not present indicate that the data is not yet stored in the associated data entry location or, similarly with logic circuitry that indicated that each of a plurality of stored memory locations have been filled. Once all of the flags are set, or there is otherwise given an indication of the parameter locations being filled then the memory location, e.g., Table I 60 or Table II 62 may be made available for access to provide information for the controller 12 and/or gate operating mechanism 11 to utilize in processing access requests, as noted above.

The other table of the Table I 60 and Table II 62 may then be loaded with duplicate information and, e.g., act as a backup in the event that something such as a power surge or the like causes the other table to contain invalid information. By way of example, check-sums may be periodically tested to verify that the currently used one of Table I and Table II remains valid, and/or other forms of checking, such as verification of the formats or the like in which particular parameters are stored are valid, can be used upon some or all parameters periodically. More likely, however, the other of the Table I 60 and Table II 62 not in operation will be subject to being updated or modified, and then substituted for the respective other Table I 60 or Table II 62. In this manner, the update or modification to the respective Table I 60 and Table II 62 that is not currently in use as the source of the operating or access parameters can be updated and validated, e.g. to insure that conflicting sources of the communication of updated or modified parameters have not concurrently sought to update the respective Table I 60 or Table II 64, causing invalidation of some parameters while other may be those desired. In this manner, e.g., if a remote server 36 is attempting to update parameters at the same time as, e.g., a technician at the I/O device 16, the system will only allow the updated one of the Table I 60 or Table II 62 to become the operating table if all of the inputs from the one source are present in the table and not a mixture of parameters from two or more sources. This may be done, e.g., by utilizing coded flags that identify the source of a modification and only allowing a Table I 60 or Table II 62 to be substituted if all data entries in the respective Table I 60 or Table II 62 have not only a flag, but the same flag. It will also be understood that some or all of the data entries may be nulls, e.g., being defaulted to nulls, unless expressly updated or modified, or may be defaulted to remain as in the one of the Table I 60 or Table II 62 that is on line, unless expressly modified by the source of th3e update or modification.

In this manner, before the currently used one of the Table I 60 or Table II 62 is removed from operation as the source of parameter information for the operation of the security gate the other of the Table I 60 or Table II 62 is established as a newly created, complete and verified table created and ready to be substituted for the one of the Table I 60 or Table II 62 that is currently on line. By way of example, a software pointer may be set to indicate that the one or the other of Table I and Table II is the active table, and resetting that pointer to the other of the Table I or Table II once it is ready for substitution may be used to substitute the one of the Table I and Table II to which the new pointer points.

It will be understood by those in the art that the switch 64 may be implemented in software or hardware or a combination of both. By way of example, the controller 12 or gate operating mechanism 11 or remote access from, e.g., server 36, or whatever part of the system 10 is seeking to update the parameter being used by the system 10 may be enabled, through software or logic circuitry represented by switch 64, to scan the address locations in memory 18 comprising Table I, where Table II is the Table currently in use, to see if all of the appropriate flags are set, or otherwise to indicate that Table I is complete and verified as noted above. In this event, the controller 12, or gate operating mechanism or a combination of both can then be made to select Table I as the appropriate table containing the most updated parameters. It will also be understood that Table I and Table II may comprise additional tables or subsections of tables, e.g., to sep arately update and/or modify, e.g., operating parameters and access parameters and/or to update and/or modify either or both of these, but particularly access parameters on the basis of individual subscribers, e.g., residents within a gated complex, who may wish individually to update access parameters. It will be understood that when only a portion of the one of Table I and Table II that is being updated is to be updated or modified, then the system may require that all of the flags in the entire table be updated to indicate that the entire one of the Table I or Table II is ready for use, or may only require that the table or sub-table being updated is given new flags. Thus the system 10 may be given an indication that the other of the Table I or Table II is ready for use by having all of its flags set to a particular flag, which may be the same as or different from the flag indicating that the one of the Table I and Table II currently in use is valid for use, or the other of the Table I and Table II, if formed of multiple tables and/or sub-tables may have all of the flags throughout the entire Table I or Table II set to a particular flag, or may have the multiple tables and/or sub-tables have distinct flags that each must be set to in order to indicate the entire one of the Table I or Table II is valid and ready for use. In any event, the system will be programmed to only switch to another of the Table I or Table II which is not currently in use when the indication is given that the entire another of the Table I or Table II has been updated or modified. In another aspect of the present invention, the figurative hardware/software switch 64 may be used to insure that different input sources are not able to update/modify the one of the Table I or Table II or its constituent or sub-tables, at the same time. This can be accomplished, e.g., by some form of input/output bus control exercised by the controller 12, I/O device 16 and/or the memory 18 itself, and may be instigated remotely from the input devices, e.g., telephone 34, server 36 or wireless input device 38. This may be accomplished through, e.g., coded inputs, which the bus control system can screen for the appropriate input device, 3.g., 34, 36, 38 or 16. It may also be implemented by unique flags associated with the updating from a particular input. In this manner, the system 10 can be assured that the inputs to update or modify parameters in the memory 18, i.e., in the one of the Table I or Table II that is not currently on line, are all received in a given time period from one possible input device, and if a conflict somehow occurs such that inputs received from different input devices contemporaneously to the same table or sub-table the system will not recognize the update or modification as valid and will not allow switching to the non-valid table or sub-table.

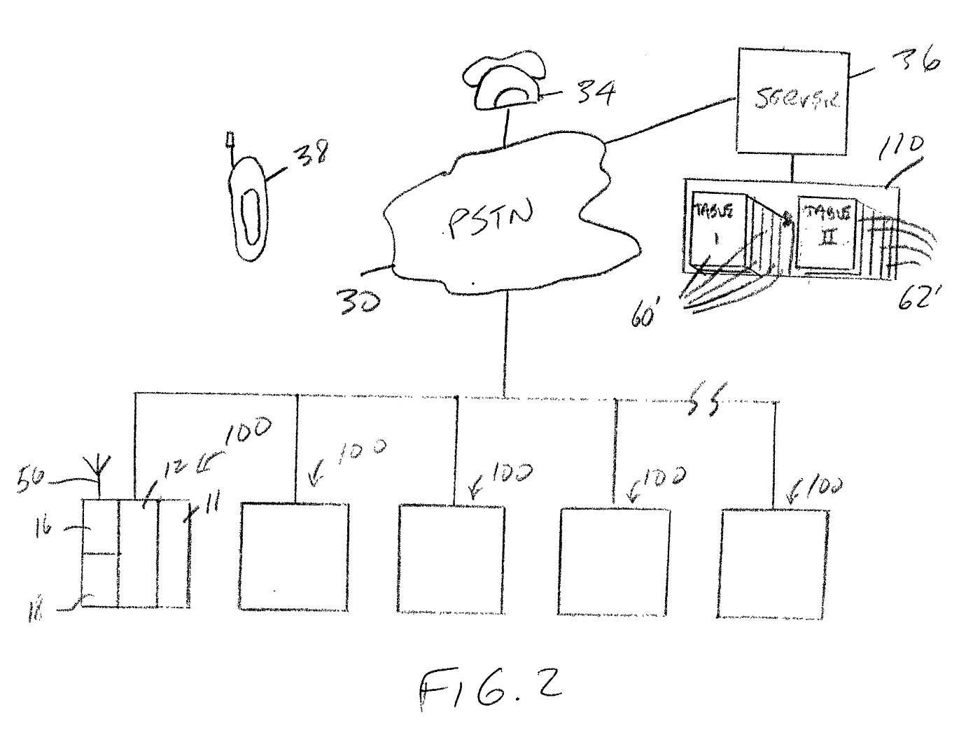

Turning now to FIG. 2 there is shown an embodiment of the present invention wherein the remote server computer 36, in addition to providing input to the local security gate operating system, or in substitution therefore, acts as a centralized security gate management system and is connected to a plurality of systems 100. Each of the systems 100 as was the case with the systems 10 shown in FIG. 1 may have a gate operating mechanism, 11, a controller 12, an I/O device 16 and a memory 18, each of which may have, as shown in FIG. 1 its own antenna, however, for convenience only one antenna 56 is shown for each system 100 in FIG. 2. The remote server 36 may have its own associated memory 110. Within the memory 110 may be stored the application software necessary to run each of the systems 100, which may be the same for every system 100 or be customized from system 100 to system 100, or may be the same for each system 20, but vary temporally, e.g., on an hourly or daily basis or on a seasonal basis, or the like.

Also stored in the memory 110 may be a Table I 60′ and a Table II 62′, which may be used as described above for all of the systems 100 to which the server 36 is connected, or, as shown in FIG. 2, a set of Tables I 60′ and Tables II 62′ each associated with at least one of the respective systems 100 to which the server 36 is connected.

According to this embodiment of the present invention, the server computer 36 may control the operation of a plurality of security gate operating systems 100 in a variety of different ways. Each of the systems 100 and/or individual components thereof, e.g., the gate operating mechanism 11, the controller 12, the I/O device 16 and/or the memory 18 may communicate with the servers computer as described above, e.g., through an internet connection using, e.g., the PSTN through a wired or wireless connection to the PSTN, and employing, e.g., a URL address for the server computer 36, or through a totally wireless connection, also employing the URL of the server computer 36. This communication may be used to download some or all of the operating system and/or applications software necessary to operate each system 100 and/or one or more of its component parts. It may also be used to download a respective one of the Table I 60′ or the table II 62′ that is valid for utilization to define the parameters for the operation of the particular system 100, or as noted above different Table I or Table II or sub-tables of a Table I or Table II, as is appropriate. This operation may be carried out at the server 36 in memory 110 such that parameter changes may be received by the server computer 36, e.g., from the respective system 100, or, e.g., subscribers or technicians or system managers through, e.g., wireless connection 38 or telephone connection or PC connection (not shown). These in turn can be used to update or modify a respective Table I or Table I as noted above, in the server 36 memory 100, and when the respective Table I or Table II is fully modified as desired, i.e., is valid, that Table I or Table II may be transmitted, e.g., over the Internet, to respective system 100, where it may be substituted for the existing Table I or Table II currently in operation, as described above, e.g., after it is fully loaded into the memory 18 at the system location, or, as noted above, directly into the controller 12 or Gate operating mechanism 11, etc. The server computer 36 may maintain in memory 110 only one Table I and Table II for utilization throughout the whole system, or may maintain a plurality of Tables I and Tables II, or sub-tables thereof, for each respective system 100. For some systems 100 some or all of the applicable tables or sub-tables may be only subject to modification at the server computer 36 and some may be subject to only modification at the system 100, or some may be subject to being updated or modified at both. In any event, the system is programmed with hardware logic and/or software to act as the switch 64 described above to determine that a Table I or Table II, or sub-tables if so organized, that is desired to be substituted for a corresponding Table I or Table II or sub-table, is valid and ready for use before the substitution is allowed.

The system of the present invention is also useful for delivery of and utilization of updates and modifications to the operating system and applications software used to monitor, control and operate the individual security gate operating systems 100. As is described above with respect to the transmission and utilization of the parameters for operating each security gate operating system 100, this can be done on a client server basis, e.g., over the Internet, such that the operating system and/or applications software and/or portions of either do not permanently reside on the system 100, but are downloaded, e.g., into main memory of the controller 12 (not shown) as opposed to being permanently stored in the memory 18 associated with the respective controller 12. Alternatively, some portions or all of the operating system and/or applications software may be maintained and updated/modified at the server computer 36 and downloaded for permanent storage and use on the memory 18 associated with each respective system 100, which will be understood to allow for customization thereof for each respective system 100 at the server computer 36 prior to the associated download to the respective system.

The present invention has been described in regard to a presently preferred embodiment of the invention but should not be limited only to this preferred embodiment. Other modification and changes to the concept of the presenting invention as embodied in the presently preferred embodiment will be understood by those skilled in the art to be possible. By way of example only, the controller 12, I/O device 16, and memory 18, or all of these and the gate operating mechanism 11 can be incorporated into a single unit, mounted, e.g., on or with the mechanical operating mechanism for the security gate. Some portions or all of these portions of the system 10 may be implemented in a single or multiple chip integrated circuit device. A separate bus control/ memory access manager unit may be included and function as switch 64 or along with some other logic circuitry and/or software comprising switch 64. References to Internet connection will be understood to include other network connections such as LANs, WANs, intranets, extranets, and the like networks, which may include at least some transmission through the PSTN, or may be through dedicated transmission lines only. These and other modifications will be understood to be part of the present invention and included within the literal language of the claims and/or equivalents of elements of the claims.

We claim:

1. A method of controlling the operation of a plurality of security gate operating mechanisms, comprising:
providing a central computer system, including an associated memory system;
providing a network connection between the central computer system and each of the plurality of security gate operating mechanisms;
storing in the associated memory system software used in operating at least some of the respective security gate operating mechanisms;
storing in the associated memory system operating system parameters for each of the respective security gate operating mechanisms;
providing over the network the software and operating parameters to respective ones of the security gate operating mechanisms.

2. The method as claimed in claim 1 further comprising:
storing the operating parameters a respective table(s) and/or sub-tables stored in the associated memory system;
updating the content of the respective table(s) and/or sub-tables for a respective security gate operating system;
providing over the internet the updated respective table(s) and/or sub-tables to the respective security gate operating mechanism;
verifying that the updated table(s) and/or sub-tables have been received at the respective security gate operating mechanism;
substituting the updated table(s) and/or sub-tables at the respective security gate operating mechanism for a currently used table(s) and/or sub-table.

3. The method of claim 1 wherein the network connection is a connection over one of the Internet, the world wide web, a local area network, a wide area network, an intranet, an extranet or a combination of one or more of these.

4. The method of claim 2 wherein the network connection is a connection over one of the Internet, the world wide web, a local area network, a wide area network, an intranet, an extranet or a combination of one or more of these.

5. The method of claim 1 wherein the network is a connection over the Internet.

6. The method of claim 2 wherein the network is a connection over the Internet.

7. The method of claim 1 wherein the network connection is over the world wide web.

8. The method of claim 2 wherein the network connection is over the world wide web.

9. The method of claim 1 wherein the step of storing comprises:
communicating over the network to the server computer system from at least one of the respective security gate operating mechanisms and/or a remote location a request to update an operating parameter and/or operating system or application software at the respective security gate operating mechanism;
processing the requested update at the server computer system; and
providing for delivery to the respective security gate operating system either the updated operating parameters and/or operating system or applications software.

10. The method of claim 2 wherein the step of storing comprises:
communicating over the network to the server computer system from at least one of the respective security gate operating mechanisms and/or a remote location a request to update an operating parameter and/or operating system or application software at the respective security gate operating mechanism;
processing the requested update at the server computer system; and
providing for delivery to the respective security gate operating system either the updated operating parameters and/or operating system or applications software.

11. A method of controlling the operation of a plurality of security gate operating mechanisms, comprising:
providing a central computer system, including an associated memory system;
providing a network connection between the central computer system and each of the plurality of security gate operating mechanisms;
storing in the associated memory system software used in operating at least some of the respective security gate operating mechanisms;
storing in the associated memory system operating system parameters for each of the respective security gate operating mechanisms;
providing the software to a respective one of the security gate operating systems on a client-server basis running the software on the central computer system as the server and utilizing the operating parameters as stored in the associated memory.

12. The method as claimed in claim 11 further comprising:
storing the operating parameters a respective table(s) and/or sub-tables stored in the associated memory system;
updating the content of the respective table(s) and/or sub-tables for a respective security gate operating system;
verifying that the updated table(s) and/or sub-tables have been properly revised;
substituting the updated table(s) and/or sub-tables in the associated memory system for a currently used table(s) and/or sub-table.

13. The method of claim 11 wherein the network connection is a connection over one of the Internet, the world wide web, a local area network, a wide area network, an intranet, an extranet or a combination of one or more of these.

14. The method of claim 12 wherein the network connection is a connection over one of the Internet, the world wide web, a local area network, a wide area network, an intranet, an extranet or a combination of one or more of these.

15. The method of claim 11 wherein the network is a connection over the Internet.

16. The method of claim 12 wherein the network is a connection over the Internet.

17. The method of claim 111 wherein the network connection is over the world wide web.

18. The method of claim 12 wherein the network connection is over the world wide web.

19. The method of claim 11 wherein the step of storing comprises:
communicating over the network to the server computer system from at least one of the respective security gate operating mechanisms and/or a remote location a request to update an operating parameter and/or operating system or application software at the respective security gate operating mechanism;
processing the requested update at the server computer system; and
providing for access on the server computer system by a respective security gate operating system either the updated operating parameters and/or operating system or applications software.

20. The method of claim 12 wherein the step of storing comprises:
communicating over the network to the server computer system from at least one of the respective security gate operating mechanisms and/or a remote location a request to update an operating parameter and/or operating system or application software at the respective security gate operating mechanism;
processing the requested update at the server computer system; and
providing for access on the server computer system by a respective security gate operating system either the updated operating parameters and/or operating system or applications software.

21. A method of controlling the operation of a plurality of security gate operating mechanisms, comprising:
providing a central computer system, including an associated memory system;
providing a network connection between the central computer system and each of the plurality of security gate operating mechanisms;
storing in the associated memory system software used in operating at least some of the respective security gate operating mechanisms;
storing in the associated memory system operating system parameters for each or the respective security gate operating mechanisms;
providing over the network some of the software and/or operating parameters to a respective one of the security gate operating mechanisms and providing access to some of the software to the respective one of the security gate operating systems on a client-server basis running the software on the central computer system as the server and utilizing the operating parameters as stored in the associated memory and/or as stored at the security gate operating mechanism.

22. The method as claimed in claim 21 further comprising:
storing the operating parameters a respective table(s) and/or sub-tables stored in the associated memory system and/or at the respective security gate operating mechanism;
updating the content of the respective table(s) and/or sub-tables for the respective security gate operating system;
verifying that the updated table(s) and/or sub-tables have been properly revised;
substituting the updated table(s) and/or sub-tables in the associated memory and/or at the respective security gate operating mechanism for a currently used table(s) and/or sub-table.

23. The method of claim 21 wherein the network connection is a connection over one of the Internet, the world wide web, a local area network, a wide area network, an intranet, an extranet or a combination of one or more of these.

24. The method of claim 22 wherein the network connection is a connection over one of the Internet, the world wide web, a local area network, a wide area network, an intranet, an extranet or a combination of one or more of these.

25. The method of claim 21 wherein the network is a connection over the Internet.

26. The method of claim 22 wherein the network is a connection over the Internet.

27. The method of claim 21 wherein the network connection is over the world wide web.

28. The method of claim 22 wherein the network connection is over the world wide web.

29. The method of claim 21 wherein the step of storing comprises:
communicating over the network to the server computer system from at least one of the respective security gate operating mechanisms and/or a remote location a request to update an operating parameter and/or operating system or application software at the respective security gate operating mechanism;
processing the requested update at the server computer system; and
providing for delivery to and/or access by the respective security gate operating system either the updated operating parameters and/or operating system or applications software.

30. The method of claim 22 wherein the step of storing comprises:
communicating over the network to the server computer system from at least one of the respective security gate operating mechanisms and/or a remote location a request to update an operating parameter and/or operating system or application software at the respective security gate operating mechanism;
processing the requested update at the server computer system; and
providing for delivery to and/or access by the respective security gate operating system either the updated operating parameters and/or operating system or applications software.

31. A security gate operating mechanism controlling apparatus for controlling the operation of a plurality of security gate operating mechanisms, comprising:
a central computer system, including an associated memory system;
a network connection between the central computer system and each of the plurality of security gate operating mechanisms;
the associated memory system having stored therein software used in operating at least some of the respective security gate operating mechanisms;
the associated memory system having stored therein operating system parameters for each of the respective security gate operating mechanisms;
the network connection being adapted to provide over the network the software and operating parameters to respective ones of the security gate operating mechanisms.

32. The apparatus as claimed in claim 31 further comprising:
the associated memory system having a respective table(s) and/or sub-tables in which the operating parameters are stored;
an mechanism adapted to update the content of the respective table(s) and/or sub-tables for a respective security gate operating system;
the network connection being adapted to provide over the internet the updated respective table(s) and/or sub-tables to the respective security gate operating mechanism;
a verification mechanism at the respective security gate operating mechanism adapted to verify that the updated table(s) and/or sub-tables have been received at the respective security gate operating mechanism;
a substitution mechanism adapted to substitute the updated table(s) and/or sub-tables at the respective security gate operating mechanism for a currently used table(s) and/or sub-table.

33. The apparatus of claim 31 wherein the network connection is a connection over one of the Internet, the world wide web, a local area network, a wide area network, an intranet, an extranet or a combination of one or more of these.

34. The apparatus of claim 32 wherein the network connection is a connection over one of the Internet, the world wide web, a local area network, a wide area network, an intranet, an extranet or a combination of one or more of these.

35. The apparatus of claim 31 wherein the network is a connection over the Internet.

36. The apparatus of claim 32 wherein the network is a connection over the Internet.

37. The apparatus of claim 31 wherein the network connection is over the world wide web.

38. The apparatus of claim 32 wherein the network connection is over the world wide web.

39. The apparatus of claim 31 wherein the server computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a transmitter connected to the network connection adapted to deliver to the respective security gate operating system either the updated operating parameters and/or operating system or applications software.

40. The apparatus of claim 32 wherein the server computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a transmitter connected to the network connection adapted to deliver to the respective security gate operating system either the updated operating parameters and/or operating system or applications software.

41. A security gate operating mechanism controller for controlling the operation of a plurality of security gate operating mechanisms, comprising:
a central computer system, including an associated memory system;
a network connection between the central computer system and each of the plurality of security gate operating mechanisms;
the associated memory having stored therein software used in operating at least some of the respective security gate operating mechanisms;
the associated memory system having stored therein operating parameters for each of the respective security gate operating mechanisms;
the central computer system being adapted to provide the software to a respective one of the security gate operating systems on a client-server basis running the software on the central computer system as the server and utilizing the operating parameters as stored in the associated memory.

42. The apparatus of claim 11 further comprising:
the associated memory having a respective table(s) and/or sub-tables in which the operating parameters for each respective security gate operating mechanism are stored;
an updating mechanism adapted to update the content of the respective table(s) and/or sub-tables for a respective security gate operating system;
a verification mechanism adapted to verify that the updated table(s) and/or sub-tables have been properly revised;
a substituting mechanism adapted to substitute the updated table(s) and/or sub-tables in the associated memory system for a currently used table(s) and/or sub-table.

43. The apparatus of claim 41 wherein the network connection is a connection over one of the Internet, the world wide web, a local area network, a wide area network, an intranet, an extranet or a combination of one or more of these.

44. The apparatus of claim 42 wherein the network connection is a connection over one of the Internet, the world wide web, a local area network, a wide area net work, an intranet, an extranet or a combination of one or more of these.

45. The apparatus of claim 41 wherein the network is a connection over the Internet.

46. The apparatus of claim 42 wherein the network is a connection over the Internet.

47. The apparatus of claim 41 wherein the network connection is over the world wide web.

48. The apparatus of claim 42 wherein the network connection is over the world wide web.

49. The apparatus of claim 41 wherein the central computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.

50. The apparatus of claim 42 wherein the step of storing comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.

51. A security gate operating mechanism control system for controlling the operation of a plurality of security gate operating mechanisms, comprising:
a central computer system, including an associated memory system;
a network connection between the central computer system and each of the plurality of security gate operating mechanisms;
the associated memory system having stored therein software used in operating at least some of the respective security gate operating mechanisms;
the associated memory system having stored therein parameters for each of the respective security gate operating mechanisms;
the central computer system being adapted to provide over the network some of the software and/or operating parameters to a respective one of the security gate operating mechanisms and providing access to some of the software to the respective one of the security gate operating systems on a client-server basis running the software on the central computer system as the server and utilizing the operating parameters as stored in the associated memory and/or as stored at the security gate operating mechanism.

52. The apparatus as claimed in claim 51 further comprising:
the apparatus having stored therein the operating parameters in a respective table(s) and/or sub-tables stored in the associated memory system and/or at the respective security gate operating mechanism;
an updating mechanism at the central computer system and at the respective security gate operating mechanism adapted to update the content of the respective table(s) and/or sub-tables for the respective security gate operating mechanism, respectively at the central computer system or at the respective security gate operating mechanism;
a verifying mechanism at the central computer system and at the respective security gate operating mechanism adapted to verify that the updated table(s) and/or sub-tables have been properly revised;
a substitution mechanism at the central computer system and at the respective security gate operating mechanism adapted to substitute the updated table(s) and/or sub-tables in the associated memory and/or at the respective security gate operating mechanism for a currently used table(s) and/or sub-table.

53. The apparatus of claim 51 wherein the network connection is a connection over one of the Internet, the world wide web, a local area network, a wide area network, an intranet, an extranet or a combination of one or more of these.

54. The apparatus of claim 52 wherein the network connection is a connection over one of the Internet, the world wide web, a local area network, a wide area network, an intranet, an extranet or a combination of one or more of these.

55. The apparatus of claim 51 wherein the network is a connection over the Internet.

56. The apparatus of claim 52 wherein the network is a connection over the Internet.

57. The apparatus of claim 51 wherein the network connection is over the world wide web.

58. The apparatus of claim 52 wherein the network connection is over the world wide web.

59. The apparatus of claim S1 wherein the central computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.

60. The apparatus of claim 52 wherein the step of storing comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.

61. A security gate operating mechanism controlling apparatus for controlling the operation of a plurality of security gate operating mechanisms, comprising:
a central computer system, including an associated memory system;
a network connection between the central computer system and each of the plurality of security gate operating mechanisms;
the associated memory system having stored therein software used in operating at least some of the respective security gate operating mechanisms;
the associated memory system having stored therein operating system parameters for each of the respective security gate operating mechanisms;
means for providing over the network the software and operating parameters to respective ones of the security gate operating mechanisms.

62. The apparatus as claimed in claim 61 further comprising:
the associated memory system having a respective table(s) and/or sub-tables in which the operating parameters are stored;
an mechanism adapted to update the content of the respective table(s) and/or sub-tables for a respective security gate operating system;
the means for providing over the network including means for providing updated respective table(s) and/or sub-tables to the respective security gate operating mechanism;
a verification mechanism at the respective security gate operating mechanism adapted to verify that the updated table(s) and/or sub-tables have been received at the respective security gate operating mechanism;
a substitution mechanism adapted to substitute the updated table(s) and/or sub-tables at the respective security gate operating mechanism for a currently used table(s) and/or sub-table.

63. The apparatus of claim 61 wherein the network connection is a connection over one of the Internet, the world wide web, a local area network, a wide area network, an intranet, an extranet or a combination of one or more of these.

64. The apparatus of claim 62 wherein the network connection is a connection over one of the Internet, the world wide web, a local area network, a wide area network, an intranet, an extranet or a combination of one or more of these.

65. The apparatus of claim 61 wherein the network is a connection over the Internet.

66. The apparatus of claim 62 wherein the network is a connection over the Internet.

67. The apparatus of claim 61 wherein the network connection is over the world wide web.

68. The apparatus of claim 62 wherein the network connection is over the world wide web.

69. The apparatus of claim 61 wherein the server computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a transmitter connected to the network connection adapted to deliver to the respective security gate operating system either the updated operating parameters and/or operating system or applications software.

70. The apparatus of claim 62 wherein the server computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a transmitter connected to the network connection adapted to deliver to the respective security gate operating system either the updated operating parameters and/or operating system or applications software.

71. A security gate operating mechanism controller for controlling the operation of a plurality of security gate operating mechanisms, comprising:
a central computer system, including an associated memory system;
a network connection between the central computer system and each of the plurality of security gate operating mechanisms;
the associated memory having stored therein software used in operating at least some of the respective security gate operating mechanisms;
the associated memory system having stored therein operating parameters for each of the respective security gate operating mechanisms;
the central computer system including means for providing the software to a respective one of the security gate operating systems on a client-server basis running the software on the central computer system as the server and utilizing the operating parameters as stored in the associated memory.

72. The apparatus of claim 71 further comprising:
the associated memory having a respective table(s) and/or sub-tables in which the operating parameters for each respective security gate operating mechanism are stored;
an updating mechanism adapted to update the content of the respective table(s) and/or sub-tables for a respective security gate operating system;
a verification mechanism adapted to verify that the updated table(s) and/or sub-tables have been properly revised;
a substituting mechanism adapted to substitute the updated table(s) and/or sub-tables in the associated memory system for a currently used table(s) and/or sub-table.

73. The apparatus of claim 71 wherein the network connection is a connection over one of the Internet, the world wide web, a local area network, a wide area network, an intranet, an extranet or a combination of one or more of these.

74. The apparatus of claim 72 wherein the network connection is a connection over one of the Internet, the world wide web, a local area network, a wide area network, an intranet, an extranet or a combination of one or more of these.

75. The apparatus of claim 71 wherein the network is a connection over the Internet.

76. The apparatus of claim 72 wherein the network is a connection over the Internet.

77. The apparatus of claim 71 wherein the network connection is over the world wide web.

78. The apparatus of claim 72 wherein the network connection is over the world wide web.

79. The apparatus of claim 71 wherein the central computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.

80. The apparatus of claim 72 wherein the step of storing comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.

81. A security gate operating mechanism control system for controlling the operation of a plurality of security gate operating mechanisms, comprising:
a central computer system, including an associated memory system;
a network connection between the central computer system and each of the plurality of security gate operating mechanisms;
the associated memory system having stored therein software used in operating at least some of the respective security gate operating mechanisms;
the associated memory system having stored therein parameters for each of the respective security gate operating mechanisms;
the central computer system having means for providing over the network some of the software and/or operating parameters to a respective one of the security gate operating mechanisms and providing access to some of the software to the respective one of the security gate operating systems on a client-server basis running the software on the central computer system as the server and utilizing the operating parameters as stored in the associated memory and/or as stored at the security gate operating mechanism.

82. The apparatus as claimed in claim 81 further comprising:
the apparatus having stored therein the operating parameters in a respective table(s) and/or sub-tables stored in the associated memory system and/or at the respective security gate operating mechanism;
an updating mechanism at the central computer system and at the respective security gate operating mechanism adapted to update the content of the respective table(s) and/or sub-tables for the respective security gate operating mechanism, respectively at the central computer system or at the respective security gate operating mechanism;
a verifying mechanism at the central computer system and at the respective security gate operating mechanism adapted to verify that the updated table(s) and/or sub-tables have been properly revised;
a substitution mechanism at the central computer system and at the respective security gate operating mechanism adapted to substitute the updated table(s) and/or sub-tables in the associated memory and/or at the respective security gate operating mechanism for a currently used table(s) and/or sub-table.

83. The apparatus of claim 81 wherein the network connection is a connection over one of the Internet, the world wide web, a local area network, a wide area network, an intranet, an extranet or a combination of one or more of these.

84. The apparatus of claim 82 wherein the network connection is a connection over one of the Internet, the world wide web, a local area network, a wide area network, an intranet, an extranet or a combination of one or more of these.

85. The apparatus of claim 81 wherein the network is a connection over the Internet.

86. The apparatus of claim 82 wherein the network is a connection over the Internet.

87. The apparatus of claim 81 wherein the network connection is over the world wide web.

88. The apparatus of claim 82 wherein the network connection is over the world wide web.

89. The apparatus of claim 81 wherein the central computer system further comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.

90. The apparatus of claim 82 wherein the step of storing comprises:
a receiver connected to the network connection adapted to receive from at least one of the respective security gate operating mechanisms and/or a remote location a request to update an operating parameter and/or operating system or application software at the respective security gate operating mechanism;
a processor adapted to process the requested update at the server computer system; and
a client-server transceiver connected to the network connection adapted to provide access by the respective security gate operating system to either the updated operating parameters and/or operating system or applications software in a client-server mode and to provide security gate operating mechanism operating commands to the respective security gate operating mechanism.
